(19) United States
(12) Patent Application Publication
(10) Pub. No.: US 2026/0126616 A1
(43) Pub. Date: May 7, 2026

(54) VARIABLE TRANSFORMER ALIGNMENT TOOL FOR MOTION COMPENSATION ASSEMBLIES

(71) Applicant: Raytheon Company, Arlington, VA (US)

(72) Inventors: Nathan A. Ley, McKinney, TX (US); Griffin R. Quintero, Richardson, TX (US); Connor J. Goldstein, Frisco, TX (US)

(21) Appl. No.: 19/371,916

(22) Filed: Oct. 28, 2025

Related U.S. Application Data
(60) Provisional application No. 63/716,114, filed on Nov. 4, 2024.

(51) Int. Cl. G02B 7/182; B64D 43/00; G02B 27/64

(52) U.S. Cl. CPC G02B 7/1821; B64D 43/00; G02B 27/646

(57) ABSTRACT

An alignment tool for a transducer of an image motion compensation assembly (IMC) is provided. The tool includes a gear train along with an IMC mounting assembly. The gear train has a pinion, a gear, and a rack. The rack moves normal to the gear during gear rotation. The IMC mounting assembly is rotatable relative to the gear train and has first and second walls and a biasing mechanism on a bottom wall. The walls form a cavity within which an IMC pillow block is disposed. The IMC pillow block is biased by the biasing mechanism and biases a mirror of the IMC during alignment of the transducer. The rack engages with the LVDT when the IMC is secured to the IMC mounting assembly and aligns the transducer.

### CLAIM OF PRIORITY

This patent application claims the benefit of priority to U.S. Provisional Application Ser. No. 63/716,114, filed Nov. 4, 2024, which is incorporated by reference herein in its entirety.

### TECHNICAL FIELD

Examples relate to an alignment tool and more specifically to a tool that can align transducers for an image motion compensation assembly.

### BACKGROUND

Aircraft can experience turbulence during flight. The turbulence can affect images relating to points of interest that are being viewed at the aircraft. In order to offset the effects of turbulence and provide an image that is stable, an image motion compensation assembly (IMC) is provided. IMCs can function to stabilize images associated with points of interest such that an end-user viewing the image can view an image that is not affected by turbulence being experienced by the aircraft.

In order to stabilize an image, an IMC has a mirror that is associated with a command and feedback system. The command and feedback system can include an actuator magnet along with linear variable differential transducers (LVDTs). In order to properly stabilize an image and avoid introducing any jitter into what is being viewed by an end-user, the LVDTs need to be precisely aligned. Typically, LVDTs are aligned by hand. However, aligning LVDTs by hand can introduce alignment errors, which can negate the functionality of an IMC that uses mis-aligned LVDTs.

### BRIEF DESCRIPTION OF DRAWINGS

FIG. 1 illustrates an environment in which examples may operate.

FIG. 2 illustrates an IMC.

FIGS. 3 and 4 show an alignment tool that can be used to align LVDTs of the IMC of FIG. 2.

FIG. 5 shows an IMC mounting assembly of the alignment tool of FIG. 3.

FIG. 6 is a view of the alignment tool of FIG. 3.

FIG. 7 illustrates a front view of the IMC mounting assembly of FIG. 5.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

Examples relate to an alignment tool that can be used to align LVDTs for an IMC. The alignment tool can include a gear train and a rack that is operatively coupled with the gear train. The gear train can include pinions that are operatively coupled with a gear. The pinions along with the gear can be configured to rotate in first and second directions. The rack can be configured to move normal to the gear train as the pinions and the gear rotate in the first and second directions.

The rack can have a rack pad at a distal end of the rack that is configured to interface with a surface of a LVDT. As the rack moves normal to the gear train, the rack can move the LVDT in the same direction as the rack. Thus, the alignment tool can translate rotational movement into linear motion by virtue of the gear train and the rack. Furthermore, the gear train in conjunction with the rack can move the LVDT in a precise manner. As the combination of the gear train and the rack move the LVDT, the LVDT can be aligned with a mirror of the IMC.

The alignment tool can also have an IMC mounting assembly. The IMC mounting assembly can be configured to receive the IMC and hold the IMC in place during alignment of LVDTs. The IMC mounting assembly can include a pillow block that can bias a mirror of the IMC during the alignment of the LVDTs.

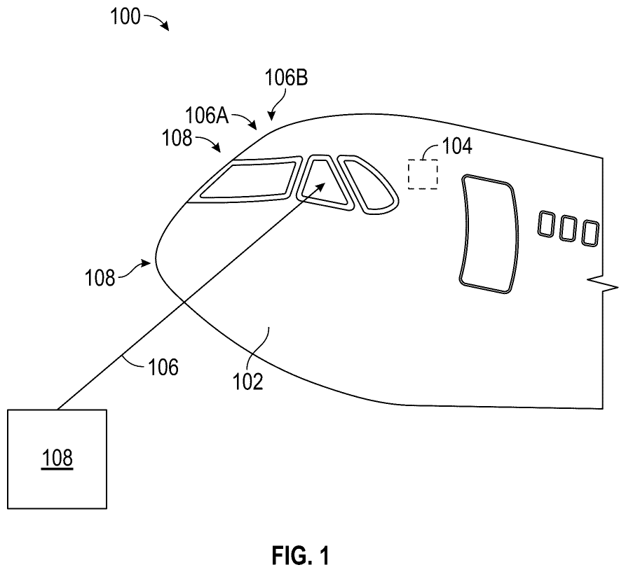

Now making reference to the Figures, FIG. 1 illustrates an environment 100 in which examples may operate. A vehicle 102, such as an aircraft, can have an IMC 104 that can function to stabilize an image (denoted by 106 and hereinafter image 106) of a target 108. While the vehicle 102 is described as being an aircraft, the vehicle 102 can be any type of vehicle, such as an automobile, a boat, a spacecraft, or the like.

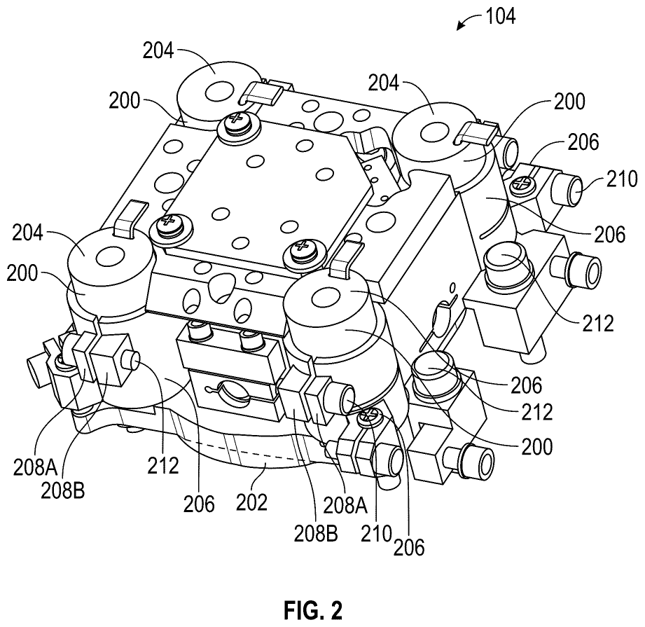

As shown with reference to FIG. 2, the IMC 104 can include LVDTs 200. The LVDTs 200 can be used to measure linear displacement. The LVDTs 200 can operate on the principle of mutual induction and can have a primary coil and two secondary coils wound on a hollow cylinder. A movable core, which can be made of a ferromagnetic material, can be placed inside the cylinder. When an alternating current is applied to the primary coil, the alternating current can induce voltages in the secondary coils. The position of the movable core can affect the induced voltages, which can be used to determine the displacement. The difference in voltage between the two secondary coils can be proportional to the position of the core, providing a precise measurement of linear movement.

When the vehicle 102 encounters turbulence, the image 106 captured at the vehicle may not be stable. The LVDTs 200 in conjunction with the IMC 104 can function to stabilize the image 106. In order to properly stabilize the image 106 during turbulence, the LVDTs 200 should be properly aligned relative to a mirror 202 of the IMC 104.

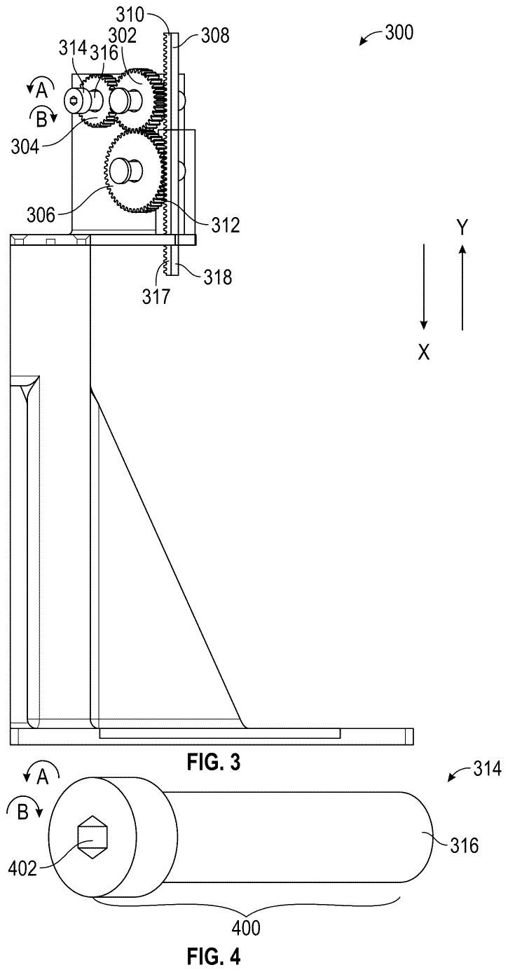

The LVDTs 200 can be properly aligned relative to the mirror 202 using an alignment tool 300, as shown with reference to FIG. 3. The alignment tool 300 can include a gear train that can comprise a first pinion 302, a second pinion 304, and a gear 306. The gear 306 can be operatively coupled to a rack 308. The rack 308 can include teeth 310 that can couple with teeth 312 of the gear 306. Thus, when the gear 306 rotates along a direction B, the gear teeth 312 can move the rack teeth 310 and the rack 308 along a direction X. Moreover, when the gear 306 rotates along a direction A, the gear teeth 312 can move the rack teeth 310 and the rack 308 along a direction Y. Thus, the rack 308 can move normal relative to the rotation of the gear 306.

The gear 306 can rotate along the direction B when the first pinion 302 rotates along the direction A. Furthermore, the gear 306 can rotate along the direction A when the first pinion 302 rotates along the B. In addition, the gear 306 can rotate along the direction B via the first pinion 302 rotating along the direction A when the second pinion 304 rotates along the direction B. The gear 306 can rotate along the direction A via the first pinion 302 rotating along the direction B when the second pinion 304 rotates along the direction A. Thus, the second pinion 304 can rotate with the first pinon 302 where the second pinion 304 rotates in a direction opposite to the first pinon 302.

The alignment tool 300 can also include a rotation mechanism 314, which can be used to rotate the second pinion 304. The rotation mechanism 314 can take any form, such as a knob, a crank, or a coupling 400 having an interface 402, as shown with reference to FIG. 4. The coupling 400 can rigidly engage with the second pinion 304 via a shaft 316. The coupling shaft 316 can be rigidly fixed to the second pinion 304, such as welding, or the like.

The coupling interface 402 can be configured to receive an engagement tool. For example, the coupling interface 402 can have a hexagonal face. The engagement tool can have an end that is complementary to the coupling interface 402, such as a hexagonal end. Therefore, a user can insert the engagement tool having an end that is complementary to the coupling interface 402 and actuate the rotation mechanism 314, such as rotating the engagement tool and the coupling 400 along the direction A or the direction B.

As the rotation mechanism 314 is rotated along the direction A via the coupling interface 402, the second pinion 304 can also rotate along the direction A along with the gear 306 via the first pinion 302. Therefore, the rack 308 can move along the direction X. Moreover, as the rotation mechanism 314 is rotated along the direction B via the coupling interface 402, the second pinion 304 can also rotate along the direction B along with the gear 306 via the first pinion 302 such that the rack 308 can move along the direction Y.

The rack 308 can also include a rack pad 317 at a distal end 318 of the rack 308. The rack pad 317 can be configured to engage with a top surface 204 of the LVDTs 200 when the IMC 104 is secured to an IMC mounting assembly. The rack pad 317 can be formed from an insulative material, such as tungsten or the like.

A user can actuate the rotation mechanism 314 and move the rack 308 along the direction X as described above. When the rack 308 moves along the direction X via the gear 306, the rack pad 317 can contact the LVDT top surface 204 via the rack pad 317. As the rack 308 moves along the direction X, the LVDT 200 can move along the direction X. The user can actuate the rotation mechanism 314 and move the LVDT 200 as previously described to align the LVDT 200 with the mirror 202. In particular, the rotational motion of the gear train can be translated to linear motion of the rack 308 via the first pinion 302, the second pinion 304, the gear 306, and the rack 308 moving normal to the gear 306 during rotation of the gear 306.

The linear motion of the rack 308 can impart precise and controlled linear motion to the LVDT 200 via the LVDT top surface 204. Therefore, the alignment tool 300 can provide a precise system for aligning the LVDT 200 relative to the mirror 202. The alignment tool 300 can be operatively coupled to a circuit card assembly. A current can be continually running through the circuit card assembly, which can be used to receive feedback from the LVDTs 200 that can relate to an alignment position of the LVDTs 200 relative to the mirror 202. The circuit card assembly can output feedback of an alignment position of the LVDTs 200 relative to the mirror 202 in real time. The output can also include a range within which the LVDTs 200 should be aligned relative to the mirror, which can also be determined based on the current.

The IMC 104 can also include clamps 206 having engagement means 208A and 208B configured to receive fasteners 210. Each of the clamps 206 can be disposed around each of the LVDTs 200 and can function to fix each of the LVDTs 200 in an alignment position. The fasteners 210 can be threaded that can engage with complementary threads within the engagement means 208A and 208B. When the fastener 210 is rotated in a first direction, by virtue of the complementary threads on the engagement means 208A and 208B, the engagement means 208A and 208B can move closer together, thereby tightening the clamp 206 around the LVDT 200 and fixing the LVDT 200 in an associated position, such as in alignment with the mirror 202. Furthermore, when the fastener 210 is rotated in a second direction opposite the first direction, by virtue of the complementary threads on the engagement means 208A and 208B, the engagement means 208A and 208B can move further apart, thereby loosening the clamp 206 around the LVDT 200.

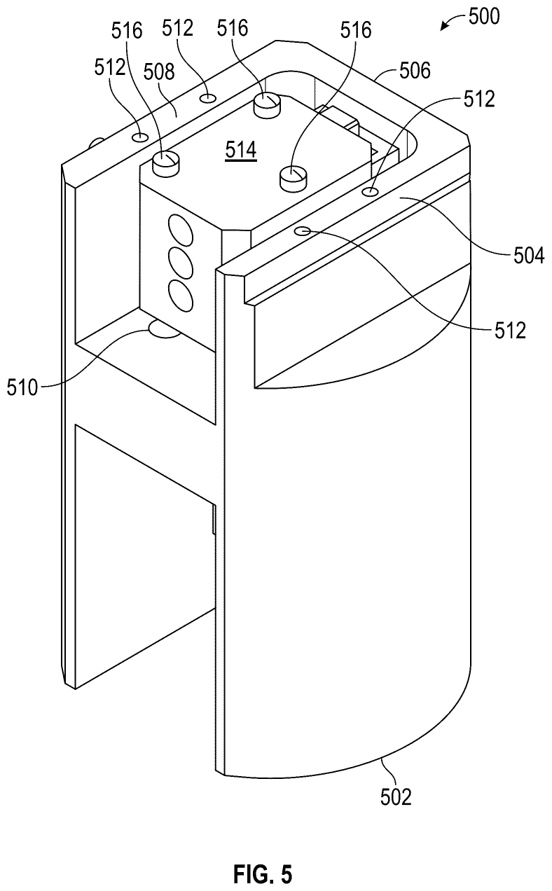

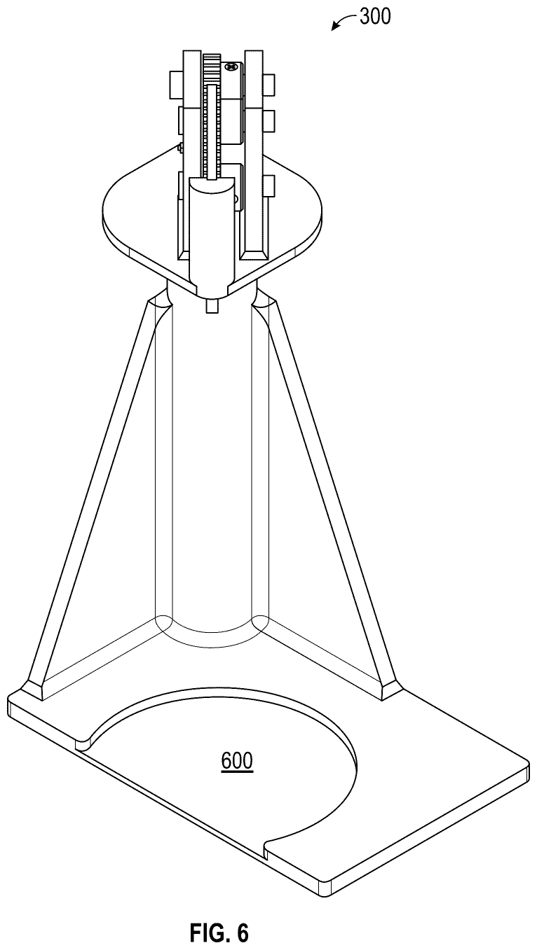

The alignment tool 300 can also include an IMC mounting assembly 500, as shown with reference to FIG. 5. The IMC mounting assembly 500 can be configured to hold the IMC 104 during alignment of the LVDTs 200. Furthermore, the IMC mounting assembly 500 can be rotatable relative to the rack 308. In particular, the alignment tool 300 can include a circular platform 600 (FIG. 6) within which the IMC mounting assembly 500 can be disposed. The IMC assembly 500 can include a bottom 502 having a circular configuration that approximates the configuration of the circular platform 600. Thus, as a user is aligning the LVDTs 200 with the rack 308, when the user has completed the alignment of a first LVDT, the user can rotate the IMC mounting assembly 500 along the circular platform 600 in order to line up a second LVDT with the rack 308 for alignment of the second LVDT.

The IMC mounting assembly 500 can be configured to secure the IMC 104 during alignment of the LVDTs 200. The IMC mounting assembly 500 can include sidewalls 504-508 along with a bottom wall 510. The sidewalls 504 and 508 can include an engagement mechanism, such as threaded cavities 512. The IMC 104 can include threaded fasteners 212. The threaded cavities 512 can include threads that are complementary to the threaded fasteners 212. Thus, the IMC 104 can be secured to the IMC mounting assembly 500 via the fasteners 212 being within the threaded cavities 512.

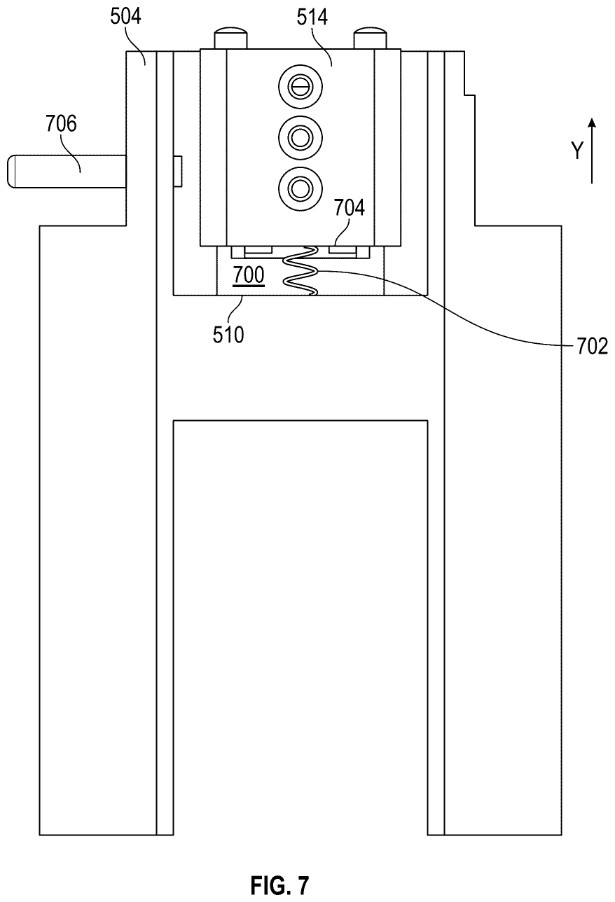

The sidewalls 504-508 along with a bottom wall 510 can define a cavity 700 (FIG. 7). An IMC pillow block 514 can be disposed within the cavity 700. The IMC pillow block 514 can include nylon pillows 516. The nylon pillows 516 can be configured to engage with the mirror 202 and hold the mirror 202 in a zero-position relative to the LVDTs 200 during the alignment of the LVDTs 200. The zero-position can refer to an alignment point or a reference point where the mirror 202 can be positioned at a neutral or baseline state. In the IMC 104, the zero-position can ensure that the mirror 202 is correctly aligned with other components, such as the LVDTs 200, in order to maintain optimal performance and accuracy. Moreover, the zero-position can serve as a starting point for adjustments or calibrations of the LVDTs 200.

Now making reference to FIG. 7, a biasing means 702, such as a compression spring, can be disposed on the bottom wall 510. The biasing means 702 can extend between the bottom wall 510 and a bottom surface 704 of the IMC pillow block 514. The biasing means 702 can bias the mirror 202 in a flat position during alignment of the LVDTs 200 in order to maintain the mirror 202 in a zero-position. The IMC mounting assembly 500 can also include a lock 706, which can lock the IMC pillow block 514 in place when the alignment tool 300 is not being used to align the LVDTs 200. The lock 706 can be can be a circular pin and can extend through one of the sidewalls 504-508 and into the IMC pillow block 514 in a locked position. When the IMC 104 is mounted to the IMC mounting assembly 500, the lock 706 can be removed from the IMC pillow block 514 such that the IMC pillow block 514 can bias the mirror 202 and hold the mirror 202 in a zero-position.

### ADDITIONAL EXAMPLES

Example 1 is an alignment tool for a linear variable differential transducer (LVDT) of a image motion compensation assembly (IMC), the alignment tool comprising: a gear train having: a pinion operatively coupled with a gear; and a rack operatively coupled with the gear, the rack configured to move normal to the gear during rotation of the gear; and an IMC mounting assembly, the IMC mounting assembly being rotatable relative to the gear train, the IMC mounting assembly including: first and second walls, each of the first and second walls having an engagement mechanism, the engagement mechanism configured to secure the IMC to the IMC mounting assembly; a biasing mechanism disposed on a bottom wall of the IMC mounting assembly, wherein the first and second walls and the bottom wall form a cavity; and an IMC pillow block disposed within the cavity, the IMC pillow block being biased by the biasing mechanism, the IMC pillow block being configured to bias a mirror of the IMC during alignment of the LVDT, wherein the rack is configured to: engage with the LVDT when the IMC is secured to the IMC mounting assembly; and align the LVDT when the rack moves normal to the gear during rotation of the gear.

In Example 2, the subject matter of Example 1 includes, wherein the pinion is a first pinion and the gear train includes a second pinion operatively coupled with the first pinion and the gear, the second pinion being configured to rotate with the first pinion and rotate the gear when the second pinion rotates with the first pinion.

In Example 3, the subject matter of Example 2 includes, wherein the alignment tool further includes a rotation mechanism operatively coupled with the second pinion, the rotation mechanism having an engagement means configured to receive an engagement tool.

In Example 4, the subject matter of Examples 2-3 includes, wherein the rack includes a rack pad where the rack pad is configured to engage with the LVDT during alignment of the LVDT.

In Example 5, the subject matter of Example 4 includes, wherein the rack pad is formed of tungsten.

In Example 6, the subject matter of Examples 1-5 includes, wherein the engagement mechanism includes a threaded cavity.

In Example 7, the subject matter of Examples 1-6 includes, wherein the biasing mechanism is a compression spring.

In Example 8, the subject matter of Examples 1-7 includes, wherein the IMC pillow block includes nylon pillows configured to engage with the IMC mirror and hold the IMC mirror in a zero-position relative to the LVDT during alignment of the LVDT.

Example 9 is an alignment tool for a linear variable differential transducer (LVDT) of a image motion compensation assembly (IMC), the alignment tool comprising: a gear train having: a pinion operatively coupled with a gear; and a rack operatively coupled with the gear, the rack configured to move normal to the gear during rotation of the gear; a rotation mechanism operatively coupled with the pinion, the rotation mechanism having an engagement means configured to receive an engagement tool; and an IMC mounting assembly, the IMC mounting assembly being rotatable relative to the gear train, the IMC mounting assembly including: first and second walls, each of the first and second walls having an engagement mechanism, the first and second walls forming a cavity, the engagement mechanism being configured to secure the IMC to the IMC mounting assembly; and an IMC pillow block disposed within the cavity, the IMC pillow block being configured to bias a mirror of the IMC during alignment of the LVDT, wherein the rack is configured to: engage with the LVDT when the IMC is secured to the IMC mounting assembly; and align the LVDT when the rack moves normal to the gear during rotation of the gear.

In Example 10, the subject matter of Example 9 includes, wherein the pinion is a first pinion and the gear train includes a second pinion operatively coupled with the first pinion and the gear, the second pinion being configured to rotate with the first pinion and rotate the gear when the second pinion rotates with the first pinion.

In Example 11, the subject matter of Example 10 includes, wherein the rack includes a rack pad where the rack pad is configured to engage with the LVDT during alignment of the LVDT and the rack pad is formed of tungsten.

In Example 12, the subject matter of Examples 9-11 includes, wherein the engagement mechanism includes a threaded cavity.

In Example 13, the subject matter of Examples 9-12 includes, wherein the IMC mounting assembly further includes a biasing mechanism disposed on a bottom wall of the IMC mounting assembly, wherein the first and second walls and the bottom wall form the cavity, the biasing mechanism being a compression spring.

In Example 14, the subject matter of Examples 9-13 includes, wherein the IMC pillow block includes nylon pillows configured to engage with the IMC mirror and hold the IMC mirror in a zero-position relative to the LVDT during alignment of the LVDT.

Example 15 is an alignment tool for a linear variable differential transducer (LVDT) of a image motion compensation assembly (IMC), the alignment tool comprising: a gear train having: a pinion operatively coupled with a gear; and a rack operatively coupled with the gear, the rack configured to move normal to the gear during rotation of the gear; and an IMC mounting assembly, the IMC mounting assembly being rotatable relative to the gear train, the IMC mounting assembly including: first and second walls, each of the first and second walls having an engagement mechanism, the first and second walls forming a cavity, the engagement mechanism being configured to secure the IMC to the IMC mounting assembly; and an IMC pillow block disposed within the cavity, the IMC pillow block being configured to bias a mirror of the IMC during alignment of the LVDT, wherein the rack is configured to: engage with the LVDT when the IMC is secured to the IMC mounting assembly; and align the LVDT when the rack moves normal to the gear during rotation of the gear.

In Example 16, the subject matter of Example 15 includes, wherein the pinion is a first pinion and the gear train includes a second pinion operatively coupled with the first pinion and the gear, the second pinion being configured to rotate with the first pinion and rotate the gear when the second pinion rotates with the first pinion and the rack includes a rack pad configured to engage with the LVDT during alignment of the LVDT, the rack pad being formed of tungsten.

In Example 17, the subject matter of Example 16 includes, wherein the alignment tool further includes a rotation mechanism operatively coupled with the second pinion, the rotation mechanism having an engagement means configured to receive an engagement tool.

In Example 18, the subject matter of Examples 15-17 includes, wherein the engagement mechanism includes a threaded cavity.

In Example 19, the subject matter of Examples 15-18 includes, wherein the IMC mounting assembly further includes a biasing mechanism disposed on a bottom wall of the IMC mounting assembly, wherein the first and second walls and the bottom wall form the cavity, the biasing mechanism being a compression spring.

In Example 20, the subject matter of Examples 15-19 includes, wherein the IMC pillow block includes nylon pillows configured to engage with the IMC mirror and hold the IMC mirror in a zero-position relative to the LVDT during alignment of the LVDT.

Example 21 is an apparatus comprising means to implement of any of Examples 1-20.

Example 22 is a system to implement of any of Examples 1-20.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. An alignment tool for a linear variable differential transducer (LVDT) of a image motion compensation assembly (IMC), the alignment tool comprising:
a gear train having:
a pinion operatively coupled with a gear; and
a rack operatively coupled with the gear, the rack configured to move normal to the gear during rotation of the gear; and
an IMC mounting assembly, the IMC mounting assembly being rotatable relative to the gear train, the IMC mounting assembly including:
first and second walls, each of the first and second walls having an engagement mechanism, the engagement mechanism configured to secure the IMC to the IMC mounting assembly;
a biasing mechanism disposed on a bottom wall of the IMC mounting assembly, wherein the first and second walls and the bottom wall form a cavity; and
an IMC pillow block disposed within the cavity, the IMC pillow block being biased by the biasing mechanism, the IMC pillow block being configured to bias a mirror of the IMC during alignment of the LVDT, wherein the rack is configured to:
engage with the LVDT when the IMC is secured to the IMC mounting assembly; and
align the LVDT when the rack moves normal to the gear during rotation of the gear.

2. The alignment tool of claim 1, wherein the pinion is a first pinion and the gear train includes a second pinion operatively coupled with the first pinion and the gear, the second pinion being configured to rotate with the first pinion and rotate the gear when the second pinion rotates with the first pinion.

3. The alignment tool of claim 2, wherein the alignment tool further includes a rotation mechanism operatively coupled with the second pinion, the rotation mechanism having an engagement means configured to receive an engagement tool.

4. The alignment tool of claim 2, wherein the rack includes a rack pad where the rack pad is configured to engage with the LVDT during alignment of the LVDT.

5. The alignment tool of claim 4, wherein the rack pad is formed of tungsten.

6. The alignment tool of claim 1, wherein the engagement mechanism includes a threaded cavity.

7. The alignment tool of claim 1, wherein the biasing mechanism is a compression spring.

8. The alignment tool of claim 1, wherein the IMC pillow block includes nylon pillows configured to engage with the IMC mirror and hold the IMC mirror in a zero-position relative to the LVDT during alignment of the LVDT.

9. An alignment tool for a linear variable differential transducer (LVDT) of a image motion compensation assembly (IMC), the alignment tool comprising:
a gear train having:
a pinion operatively coupled with a gear; and
a rack operatively coupled with the gear, the rack configured to move normal to the gear during rotation of the gear;
a rotation mechanism operatively coupled with the pinion, the rotation mechanism having an engagement means configured to receive an engagement tool; and
an IMC mounting assembly, the IMC mounting assembly being rotatable relative to the gear train, the IMC mounting assembly including:
first and second walls, each of the first and second walls having an engagement mechanism, the first and second walls forming a cavity, the engagement mechanism being configured to secure the IMC to the IMC mounting assembly; and
an IMC pillow block disposed within the cavity, the IMC pillow block being configured to bias a mirror of the IMC during alignment of the LVDT, wherein the rack is configured to:
engage with the LVDT when the IMC is secured to the IMC mounting assembly; and
align the LVDT when the rack moves normal to the gear during rotation of the gear.

10. The alignment tool of claim 9, wherein the pinion is a first pinion and the gear train includes a second pinion operatively coupled with the first pinion and the gear, the second pinion being configured to rotate with the first pinion and rotate the gear when the second pinion rotates with the first pinion.

11. The alignment tool of claim 10, wherein the rack includes a rack pad where the rack pad is configured to engage with the LVDT during alignment of the LVDT and the rack pad is formed of tungsten.

12. The alignment tool of claim 9, wherein the engagement mechanism includes a threaded cavity.

13. The alignment tool of claim 9, wherein the IMC mounting assembly further includes a biasing mechanism disposed on a bottom wall of the IMC mounting assembly, wherein the first and second walls and the bottom wall form the cavity, the biasing mechanism being a compression spring.

14. The alignment tool of claim 9, wherein the IMC pillow block includes nylon pillows configured to engage with the IMC mirror and hold the IMC mirror in a zero-position relative to the LVDT during alignment of the LVDT.

15. An alignment tool for a linear variable differential transducer (LVDT) of a image motion compensation assembly (IMC), the alignment tool comprising:
a gear train having:
a pinion operatively coupled with a gear; and
a rack operatively coupled with the gear, the rack configured to move normal to the gear during rotation of the gear; and
an IMC mounting assembly, the IMC mounting assembly being rotatable relative to the gear train, the IMC mounting assembly including:
first and second walls, each of the first and second walls having an engagement mechanism, the first and second walls forming a cavity, the engagement mechanism being configured to secure the IMC to the IMC mounting assembly; and
an IMC pillow block disposed within the cavity, the IMC pillow block being configured to bias a mirror of the IMC during alignment of the LVDT, wherein the rack is configured to:
engage with the LVDT when the IMC is secured to the IMC mounting assembly; and
align the LVDT when the rack moves normal to the gear during rotation of the gear.

16. The alignment tool of claim 15, wherein the pinion is a first pinion and the gear train includes a second pinion operatively coupled with the first pinion and the gear, the second pinion being configured to rotate with the first pinion and rotate the gear when the second pinion rotates with the first pinion and the rack includes a rack pad configured to engage with the LVDT during alignment of the LVDT, the rack pad being formed of tungsten.

17. The alignment tool of claim 16, wherein the alignment tool further includes a rotation mechanism operatively coupled with the second pinion, the rotation mechanism having an engagement means configured to receive an engagement tool.

18. The alignment tool of claim 15, wherein the engagement mechanism includes a threaded cavity.

19. The alignment tool of claim 15, wherein the IMC mounting assembly further includes a biasing mechanism disposed on a bottom wall of the IMC mounting assembly, wherein the first and second walls and the bottom wall form the cavity, the biasing mechanism being a compression spring.

20. The alignment tool of claim 15, wherein the IMC pillow block includes nylon pillows configured to engage with the IMC mirror and hold the IMC mirror in a zero-position relative to the LVDT during alignment of the LVDT.
